(19) United States
(12) Patent Application Publication
(10) Pub. No.: US 2004/0003135 A1
(43) Pub. Date: Jan. 1, 2004

(54) Technique for driver installation

(76) Inventor: Terrill M. Moore, Trumansburg, NY (US)

Correspondence Address: CESARI AND MCKENNA, LLP, 88 BLACK FALCON AVENUE, BOSTON, MA, 02210, US

(21) Appl. No.: 10/185,976

(22) Filed: Jun. 27, 2002

(51) Int. Cl. G06F 13/10

(52) U.S. Cl. 709/321

(57) ABSTRACT

A technique for accurately identifying and installing a device driver for a particular device. The inventive technique gathers information about the operating system and the device and generates one or more device identifiers by concatenating the operating system information with the device information. The generated identifiers are then used to select and install the appropriate device driver for the device.

### BACKGROUND OF THE INVENTION

1. Field of the Invention

This invention relates to the installation of software on a computer system and specifically to the installation of driver software on a computer system.

2. Background Information

A computer system can roughly be divided into the following parts: hardware, operating system, application programs, and users. The hardware provides the basic computing resources. The application programs utilize these resources to perform various functions for the users. The operating system provides an environment within which the application programs can run as software tasks to do useful work, and in particular enables the application programs to make use of various hardware resources. An operating system can be designed to run only a single software task at a time, or it may be capable of running multiple software tasks at a time concurrently. A typical operating system comprises a kernel which is usually made up of a series of software routines, often called “kernel routines,” that typically handle certain low-level tasks such as, memory allocation, software task scheduling and processing of input/output (I/O)-device requests.

The operating system typically runs in a mode known as “kernel mode,” and the software tasks typically run in a mode known as “user mode.” The kernel mode is typically a privileged mode of operation, in which this software is granted full access to the system resources. Software operating in user mode, on the other hand, is often granted only limited or no direct access to the system resources. To gain access to a restricted resource, software running in user mode typically calls a kernel routine.

Kernel routines that handle access to specific I/O devices are often called device drivers or function drivers. A function driver is typically a collection of driver routines and data that provides a software interface to a particular I/O device. When an application requires a particular I/O action the appropriate driver routine is called for the transfer of data between the application and the device driver. Control is returned to the user process when the driver routine has completed.

Function drivers are often closely associated with particular operating systems. A device may not be recognized by the operating system or operate properly, if the appropriate function driver for that operating system is not installed. Installation of a function driver typically entails locating the device driver software and having an installation routine install the driver by copying the driver to a predetermined area on a system disk, thereby making the driver part of the kernel. The installation routine will often try to locate the driver by acquiring a hardware identifier (ID) and compatibility ID associated with the device, and searching driver information (INF) files on the system disk to find INF files that match the hardware and compatibility ID information. The INF files identify the drivers corresponding to the hardware IDs. If no matching INF files are found, the installation routine may prompt the user to specify the location where a matching INF file can be found. Typically the location specified is a floppy disk or a compact-disk-read-only-memory (CD-ROM) disk that is provided by the manufacturer of the device. The location usually contains a number of drivers for different devices and operating systems, and INF files for the respective drivers. Success in installing the correct device driver often depends on the operating system's ability to locate the correct INF file and subsequently the driver on this storage medium.

For example, assume a “Plug and Play” (PnP) device is plugged into a system running the Microsoft Windows 98® operating system. The operating system recognizes that a new device has been installed and gathers device information about the device, including the device's hardware identifier (ID) and compatible ID. The operating system then uses the device information to generate one or more device identifiers that it uses to locate a driver for the device. Specifically, the operating system searches various driver information (INF) files at various predetermined locations to determine if any of the INF files contains a device identifier that matches a device identifier generated for the device. If a matching INF file cannot be found, the operating system queries the user to specify a location where the INF files for the device's driver can be found. The installation routine then searches all the INF files at the specified location to locate those INF files that match, and builds a list of possible drivers based upon information contained in the matching INF files. The installation routine then “ranks” each of the entries in the list such that entries lower in rank are considered a better match for the device than entries higher in rank. The installation routine then chooses the driver that is the best match for the device, i.e., the driver with the lowest rank.

One problem with the above-described method is that it is possible to choose and install the wrong driver. For example, assume the location specified by the user contains a matching INF file for a driver that is used with a different operating system. If the installation routine determines that that driver is the best match for the device, it will select that driver even though the driver is not the correct driver. It may be possible to avoid this problem by placing the INF files associated with different operating systems in separate directories; however, if the user inadvertently specifies the wrong directory the problem persists. Moreover, keeping a separate directory for each operating system is cumbersome and further complicates the installation process for the user.

### SUMMARY OF THE INVENTION

The present invention incorporates a technique for accurately identifying and installing a function driver for a particular device. The inventive technique gathers operating system information about the operating system and device information about the device and generates one or more device identifiers by concatenating the operating system information with the device information. The generated identifiers are then used to select and install the appropriate device driver for the device.

Briefly, in the preferred embodiment of the invention when a new device is attached to the system, the operating system determines if a device driver for the device is already installed and if not, calls an installation routine to install a driver for the device. The installation routine is caused to select an operating-system-independent-shim driver, referred to herein as a “composite driver.” The composite driver gathers operating system information associated with the operating system and device information associated with the device, generates an operating system identifier using the operating system information, and generates a device ID by concatenating the operating system identifier with the device information. The device ID is then used to locate a matching INF file and the information in the INF file is used, in turn, to select and install the appropriate function driver for the device.

Advantageously, the inventive technique improves the accuracy of installing the correct driver over current driver installation techniques by causing the installation routine to select a driver based on device and operating system information. Moreover, the inventive technique enables the driver information files for various operating systems to all reside in the same directory, thereby obviating the need to maintain separate directories for each operating system.

### BRIEF DESCRIPTION OF THE DRAWINGS

The invention description below refers to the accompanying drawings, of which:

FIG. 1 is an illustration of one type of a digital-computer system in which the present invention's teachings may be implemented;

FIG. 2 is a block diagram of a series of software components involved in installing a PnP device that can be used with the present invention;

FIG. 3 is a high-level flow diagram of a sequence of steps that can be used to implement the present invention;

FIG. 4 is a flow diagram of a sequence of steps that can be used to install a function driver associated with a device in accordance with the present invention;

FIG. 5 is a highly-schematic block diagram of a device stack in accordance with the present invention;

FIG. 6 is a flow diagram of a sequence of steps that can be used to generate a device identifier (ID) and create a Physical Device Object (PDO) in accordance with the present invention; and

FIG. 7 illustrates an example of device identifiers that are generated using the inventive technique.

### DETAILED DESCRIPTION OF AN ILLUSTRATIVE EMBODIMENT

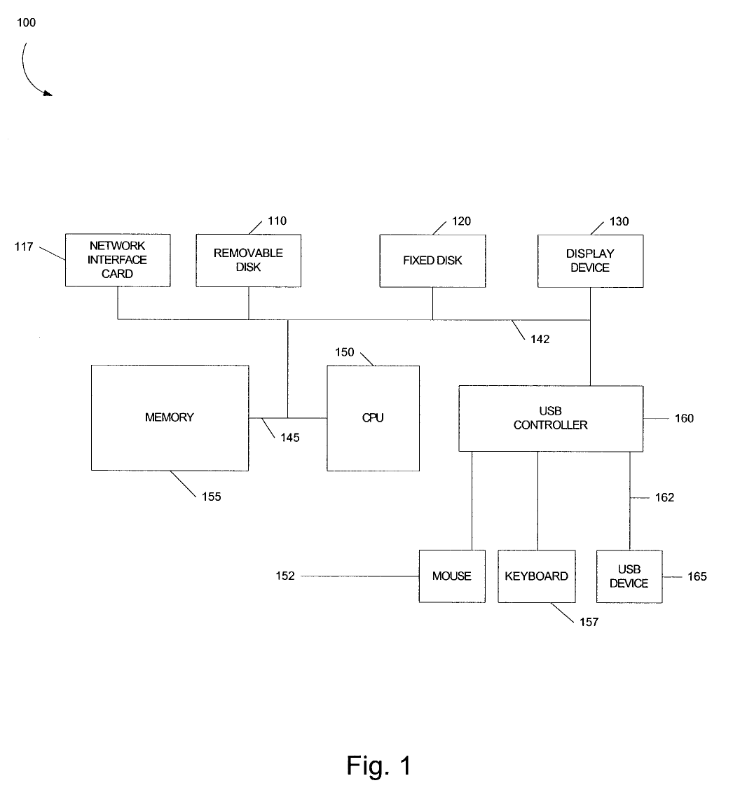

FIG. 1 is an illustration of an exemplary digital-computer system that can advantageously implement the present invention. The digital-computer system 100 comprises a central processing unit (CPU) 150, interconnected with a memory 155, and various Input/Output (I/O) devices including a Universal Serial Bus (USB) controller 160, a USB device 165, a mouse 152, a keyboard 157, a network interface card (NIC) 117, a display device 130, a fixed disk 120 and a removable disk 110. The system 100 may include a disk controller (not shown) that enables various data and control signals to be transferred between the disks and the CPU 150.

The memory 155 is a computer-readable medium that is connected to CPU 150 and is configured to hold data and instructions, including data and instructions that are used to perform the inventive technique. The memory 155 may comprise one or more memory devices (not shown) such as, synchronous dynamic random access memory devices. The CPU 150 comprises various logic elements that are configured to, inter alia, execute instructions and manipulate data contained in the memory 155 including instructions that implement the present invention, as well as instructions that perform I/O operations on the various I/O devices contained in the system 100, including operations that enable CPU 150 to recognize and identify devices attached to the system 100.

USB device 165 is a serial device such as, a joystick, gamepad or scanner, which is configured to communicate with the USB controller 160 over the bus 162. The USB controller contains logic that enables the CPU 150 to communicate with the USB device 165. The bus 162 is a point-to-point bus that connects USB device 165 to the controller 160. The system conceptually includes a system bus 145 that comprises logic and a point-to-point bus that enables signals and data to be transferred between the CPU 150, the memory 155 and the I/O subsystem. Bus 142 is a standard bus, such as the Peripheral Component Interconnect (PCI) bus, that comprises logic and a point-to-point bus that interconnects the various devices to CPU 150, through the system bus 145, and enables the devices to transfer data and control signals to and from the CPU 150, respectively.

The system 100 operates under control of an operating system (not shown), such as the Microsoft® Windows® operating system available from Microsoft Corporation, Redmond, Wash. The operating system contains various kernel routines, including device drivers that are used to communicate with the various I/O devices. These routines contain instructions that, inter alia, issue commands to a device to transfer information between the memory 155 and the device. Moreover, the operating system contains software that enables device drivers to be installed in accordance with the present invention.

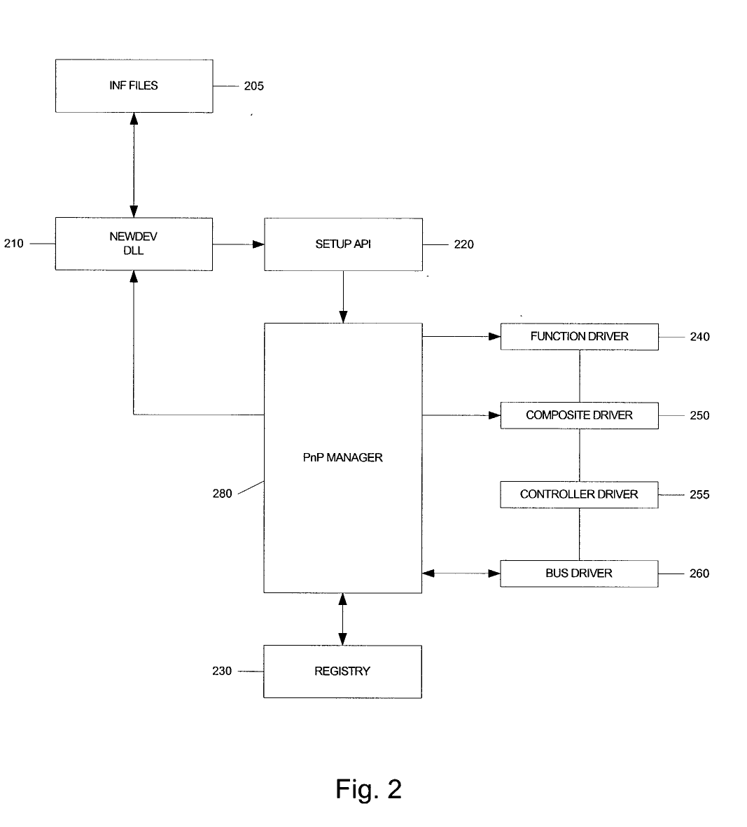

Suppose, for example, that device 165 is a new PnP device that a user attaches to the USB 162. Further assume that the function driver for device 165 has not been previously installed. FIG. 2 is a block diagram of various software components that might be used by the operating system to install a driver for device 165. The software components include INF files 205, a New Device Dynamic-Linked Library (NEWDEV) 210, a Setup Application Programming Interface (SETUP) 220, a device registry 230, a PnP manager 280, a USB driver 260, a function driver 240, and a composite driver 250.

The INF files 205 are a collection of driver information (INF) files that comprises information about drivers located on various storage media contained in the system 100 or on a data network connected to the NIC 117. NEWDEV 210 is a software library that comprises software routines that are used to initiate the installation of a driver associated with a new device. SETUP 220 is an application-programming interface (API) that comprises software routines that perform various device driver installation tasks such as searching the INF files and building a potential list of device drivers associated with the new device. The registry 230 is a database that comprises information about installed devices attached to the system including information about each device's associated installed device driver. The PnP manager 280 comprises routines that interact with various operating system components to configure, manage, and maintain various I/O devices.

The bus driver 260 comprises routines that perform various operations on behalf of the devices attached to the bus 162. For example, the bus driver 260 accesses various registers in the devices to identify the devices and thereby generate device identifiers (IDs) for the devices. Controller driver 255 is a driver that is associated with USB controller 160. Composite driver 250 is a shim driver that comprises routines that implement the inventive technique.

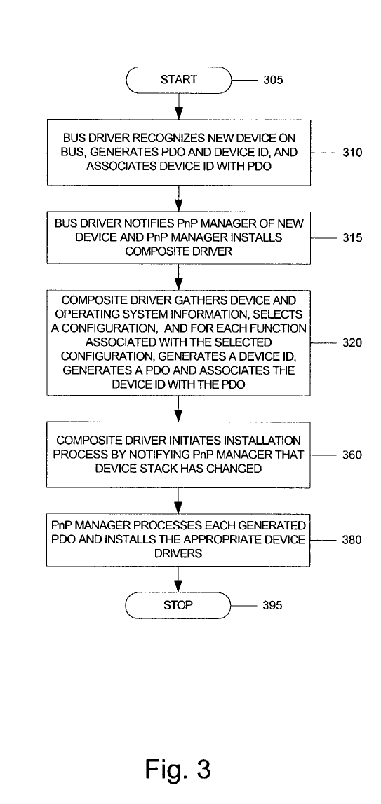

FIG. 3 is a flow diagram of a sequence of steps the operating system may use to install a device driver for device 165 in accordance with the inventive technique. The sequence begins at Step 305 and proceeds to Step 310 where the bus driver 260 associated with the USB recognizes that device 165 has been added to system 100, generates a Physical Device Object (PDO) 525 and one or more device IDs for the device, and associates the device IDs with the PDO. Specifically, bus driver 260 reads the device descriptor from the device and forms device identifiers including a hardware ID and a composite ID from information contained in the device descriptor. The device descriptor contains information about the device, including information such as a vendor code, product code, and revision code associated with the device. The bus driver 260 then places the PDO on the device stack 500 and associates the hardware and compatibility Is IDs with the PDO.

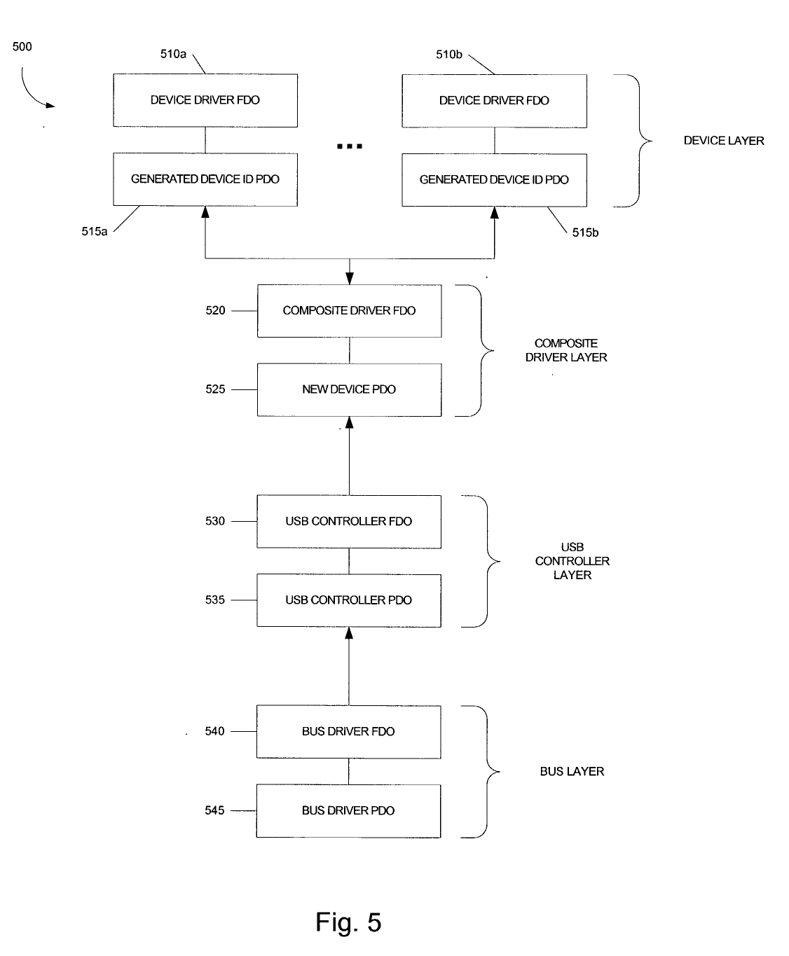

FIG. 5 is a block diagram of the device stack 500. It comprises one or more layers, where each layer is associated with a particular driver and comprises one or more Functional Device Objects (FDOs) and PDOs. A PDO is a device object that represents a device on a bus to the bus driver. An FDO is a device object that represents a device to the function driver associated with the layer. Both the PDO and FDO contain pointers to code contained in their associated drivers that implements the behavior of the device object. For example, the FDO contains pointers to routines in the associated driver that implement functions provided by the FDO. One of these functions may be a function that processes I/O Request Packets (IRPs) sent to the device stack.

Referring again to FIG. 3, at Step 315 the bus driver 260 notifies the PnP manager 280 that the device stack 500 has changed and in response the PnP manager 280 installs the composite driver 250.

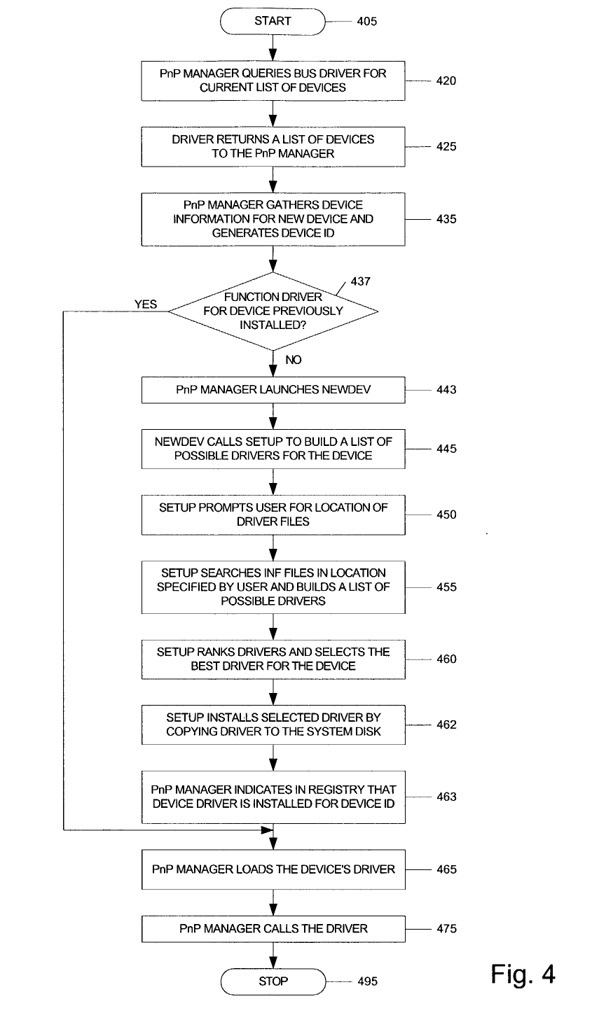

More specifically, as shown in FIG. 4 the installation sequence begins at Step 405 and proceeds to Step 420 where the PnP manager 280 queries the bus driver 260 for a current list of devices attached to the USB 162. The bus driver 260, in turn, responds with a list of devices, as indicated at Step 425.

At Step 435, the PnP manager 280 then compares the returned list of devices to a list of known devices, identifies device 165 as a new device, and gathers information about device 165 by sending a sequence of IRPs to the device stack 500. The device stack 500 responds by returning various device information about device 165 to the PnP manager 280 including the hardware ID and a compatible ID associated with PDO 525.

Next at Step 437, the PnP manager 280 determines if a driver for device 165 has already been installed. Specifically, PnP manager 280 searches the registry 230 for entries that match the device IDs. Each matching entry is then examined to determine if a driver is installed for the matching device ID. Preferably, a device driver for a particular device ID is considered installed if a device driver file that contains the device driver's code already exists in a predetermined location on the system disk, and the registry contains a matching entry that indicates the driver is installed. If the device driver for device 165 has been installed, the sequence proceeds to Step 465. If the registry does not contain a matching entry or a matching entry is found but it does not indicate the driver is installed, the sequence proceeds to step 443. Assume a device driver for device 165 has not been installed, at Step 443 the PnP manager 280 launches NEWDEV 210 and passes the device ID to NEWDEV 210.

At Step 445, NEWDEV 210 calls SETUP 220 to build a list of possible drivers that can be used with device 165. SETUP 220 prompts the user to specify the location of the INF files associated with device 165's driver, as indicated at Step 450. The location specified could be, for example, a directory on a CD-ROM contained in removable disk 110 or a disk drive on the data network that is accessible through NIC 117. At Step 455, SETUP 220 searches the user specified location to find INF files that contain information that matches the device IDs. If an INF file is found to match, device driver information contained in the matching INF file that specifies a particular driver is added to the list of possible drivers. Preferably, the location specified by the user contains a single matching INF file that contains device ID information that matches the hardware ID of the device and driver information that specifies the composite driver 250. Assume that SETUP has found this matching INF file.

Next at Step 460, SETUP 220 assigns a rank to each possible driver in the list and selects the best driver for device 165. The rank indicates how well the driver matches the device. The lower the rank number, the better a match the driver is for the device. The driver with the lowest rank is selected as the driver for the device. If two drivers have the same rank, the driver with the most recent date is selected. In accordance with the inventive technique, the INF file associated with the composite driver is configured to take into consideration the technique used to rank the drivers such that the composite driver 250 is the driver that is selected. To that end, assume the INF file associated with the composite driver 250 is configured accordingly and that the composite driver is selected.

The composite driver 250 is then installed by copying the driver from the user specified location into a file located at a predetermined location on the system disk 120 and placing an entry in the registry 230 that indicates the device driver for the matching device ID has been installed by recording in the registry that the driver has been installed on the system 100, as indicated at Steps 462 and 463. Next at Steps 465 and 475, the PnP manager 280 loads the composite driver 250 into memory 155 and calls driver 250's initialization routine, which generates FDO 520 for the driver and attaches the FDO to the device stack 500. The sequence ends at Step 495.

Referring again to FIG. 3, at Step 320 the composite driver 250 gathers information about device 165 and the operating system, selects a configuration associated with the device 165, and for each function associated with the selected configuration, generates a device ID and a PDO, associates the device ID with the PDO, and places the PDO on device stack 500.

The device information that is gathered and the way it is gathered depends on the type of device. As indicated above, device 165 is a USB device. Thus the composite driver 250 gathers information about device 165 by reading device 165's USB device descriptor and configuration descriptor information and selecting a USB configuration to be used. Well known methods exist for reading a USB device's device and configuration descriptor and identifying a USB device's functions. A method that could be used is described in the Universal Serial Bus Specification, Revision 2.0, available from the USB Implementors Forum, Inc., http://www.usb.org.

The device descriptor describes information about the USB device, such as vendor ID, product ID, and revision number and the number of configuration descriptors. Each configuration descriptor contains information about an operating configuration of the device. Included in this information is information about interfaces associated with the configuration. The interface information includes a class code, subclass code, and protocol associated with each interface. The class and subclass codes are codes that are used to classify the interface and the protocol specifies the protocol used by the interface. Typically, a USB device has only one device descriptor. This descriptor may be associated with many configurations, each configuration may be associated with one or more functions, and each function may be associated with one or more interfaces.

Assume that device 165 has only one device descriptor. The composite driver 250 gathers operating system and device information, generates one or more device identifiers using this information, generates a PDO for each function associated with device 165, associates the device identifier information with the PDO and places the PDO on the device stack 500.

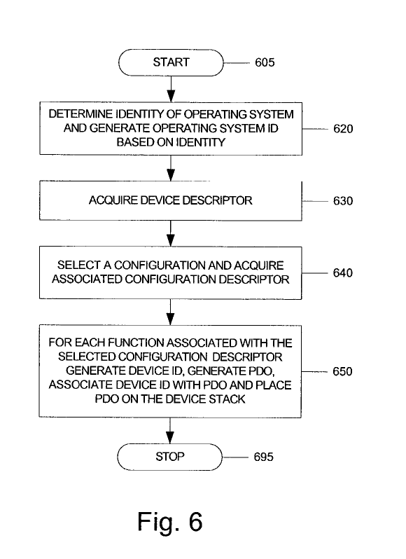

FIG. 6 is a flow diagram of a sequence of steps that can be used to gather operating system and device information and generate the device identifiers. The sequence begins at Step 605 and proceeds to Step 620 where the composite driver 250 determines the identity of the operating system and generates an operating system ID based on the identity. Preferably, the operating system is identified by calling a DLL routine that returns a value that allows the composite driver 250 to determine the identity of the operating system. The composite driver 250 then uses the identity to generate the operating system ID. Preferably, the operating system ID is in the form of “OS_XX” where “XX” identifies the particular operating system. Thus, for example, the preferred operating system ID would be “OS_{—}9x” for the Microsoft® Windows® 98, 98se, and ME operating systems and “OS_NT” for the Microsoft® Windows® NT®, 2000, and XP operating systems.

Next at Step 630, the composite driver 250 acquires the device descriptor from device 165. The composite driver 250 then, at Step 640, selects a configuration associated with the device and acquires the configuration descriptor associated with the selected configuration. Next, for each function associated with the configuration descriptor, the composite driver 250 generates a device ID, generates a PDO 515, associates the device ID with the PDO 515 and places the PDO 515 on the device stack 500, as indicated at Step 650. Preferably, the device ID is generated by concatenating the operating system ID with the device descriptor information and configuration descriptor information (configuration bundle) to form a character string that represents the device and operating system.

For example, suppose the gathered device information for device 165 contains a vendor ID of “0x040E”, a product ID of “0xF109”, a revision number of “0x0000”, and a device class of“0x02” and a configuration bundle containing:

a first USB interface descriptor with class “0x02”, subclass “0x02”, and protocol “0x01”;

a second USB interface descriptor with class “0x0A”, subclass “0x00”, and protocol “0x00”; and

a union descriptor associated with the first USB interface descriptor, indicating that the first USB interface descriptor is the controlling interface of the communication function, and the second USB interface descriptor is the subordinate interface of the communication function.

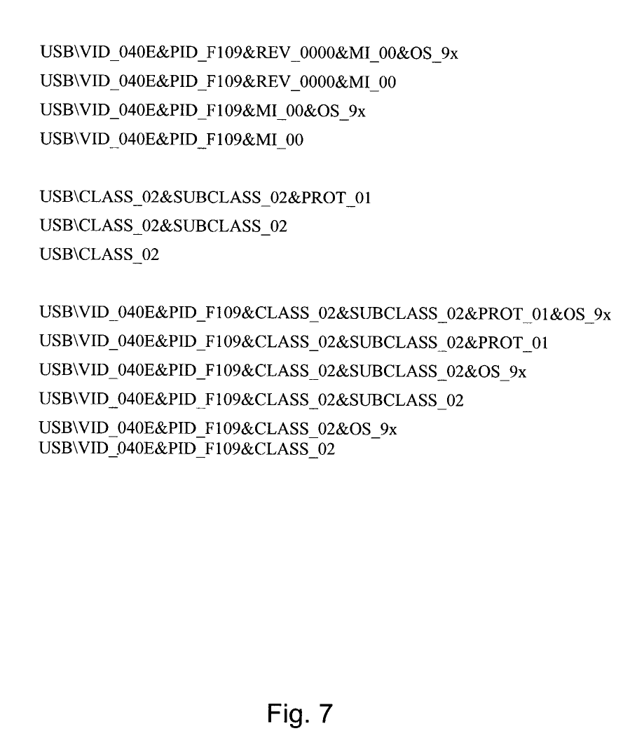

Further assume the operating system is the Microsoft® Windows® 98 operating system and the operating system ID is “OS_{—}9x”. FIG. 7 illustrates the device IDs that are generated.

Preferably, the device IDs generated allow the following types of INF files to be matched:

INF files provided by the operating system, that load drivers for generic classes of devices, e.g., USB mouse, keyboard, mass storage device;

INF files provided by the vendor, that load drivers for use in a specific operating system, for a specific portion of the device using the MI_ii&OS_zz notation;

INF files provided by the vendor, that load drivers for use on any operating system, for a specific portion of the device using the MI_ii notation;

INF files provided by the vendor, that load drivers for use with any matching portion of the device, for a specific OS using the VID_vvvv&PID_ppp&CLASS_cc . . . &OS_zz notation; and

INF files provided by the vendor, that load drivers for use with any matching portion of the device, for any OS using the VID_vvvv&PID_pppp&CLASS_cc . . . notation.

The sequence then ends at Step 695.

Referring again to FIG. 3 at Step 360, the composite driver 250 then initiates the installation process by notifying the PnP manager 280 that the device stack 500 has changed, i.e., a PDO 515 for each function has been added to the device stack 500. At Step 380, the PnP manager 280 processes each new PDO 515 and selects and installs an appropriate function driver using the generated device IDs. Specifically, the PnP manager 280 repeats Steps 437 through 475 (FIG. 4) for each PDO 515 in a manner as described above and installs the appropriate function driver for the PDO.

Although the above-described embodiment describes the invention as it is used with the Microsoft® Windows® operating system, this is not intended to be a limitation of the invention. Rather, the inventive technique can be applied to other operating system environments where the device driver for a particular device is installed based on a device identifier.

It should be noted that the above-described embodiment of the invention describes the invention as it could be used with USB devices and that the device information gathered includes a device and configuration descriptor associated with the device; however, this is not a limitation of the invention. Rather, other devices may be used with the invention, such as a device attached to a PCI or Industry Standard Architecture (ISA) bus and the device information gathered may include information other than a device and configuration descriptor. For example in other embodiments of the invention, the device information is gathered from a register or a data structure associated with the device. Likewise in another embodiment of the invention, the device is a USB device and the device information includes only the information contained in the device descriptor.

In summary, the present invention incorporates a technique for installing device drivers. The inventive technique utilizes a composite driver to identify the operating system and generate a device ID that is then used by the installer software to select an appropriate device driver for the device. It will be apparent, however, that other variations and modifications may be made to the described embodiments, with the attainment of some or all of their advantages. Therefore, it is an object of the appended claims to cover all such variations and modifications as come within the true spirit and scope of the invention.

What is claimed is:

1. In a computer system comprising an operating system and a device, a method for installing a device driver for the device, the method comprising the steps of:
gathering operating system information associated with the operating system and device information associated with the device;
generating a device identifier by concatenating the operating system information with the device information;
selecting the device driver using the device identifier; and
installing the selected device driver.

2. A method as in claim 1 wherein the step of gathering further comprises the steps of:
determining the identity of the operating system; and
generating an operating system identifier based on the identity of the operating system.

3. A method as in claim 2 wherein the step of generating further comprises the step of:
concatenating the device information with the operating system identifier to generate the device identifier.

4. A method as in claim 2 wherein the step of gathering further comprises the steps of:
acquiring device descriptor information contained in a device descriptor associated with the device; and
acquiring configuration information contained in a configuration descriptor associated with the device.

5. A method as in claim 4 wherein the step of generating further comprises the step of:
concatenating the device descriptor information and the configuration descriptor information with the operating system identifier to generate the device identifier.

6. A method as in claim 1 wherein the step of selecting the device driver further comprises the steps of:
searching driver information (INF) files to find a matching INF file that contains information that matches the device identifier; and
selecting the device driver using driver information contained in the matching INF file.

7. A method as in claim 1 wherein the computer system further comprises a system disk and the step of installing the selected device driver further comprises the steps of:
copying the selected driver to the system disk; and
indicating in a registry that the selected device driver is installed.

8. A method as in claim 1 further comprising the step of:
installing a shim driver.

9. A method as in claim 1 wherein the step of gathering further comprises the step of:
gathering the device information from a register associated with the device.

10. A method as in claim 1 wherein the step of gathering further comprises the step of:
gathering the device information from a data structure associated with the device.

11. A computer system comprising:
a device;
an operating system configured to gather operating system information associated with the operating system and device information associated with the device, generate a device identifier by concatenating the operating system information with the device information, select a device driver using the device ID and install the selected device driver.

12. A computer system as in claim 12 wherein the operating system is further configured to determine the identity of the operating system, generate an operating system identifier based on the identity of the operating system and concatenate the device information with the operating system identifier to generate the device identifier.

13. An apparatus configured to operate an operating system and to install a device driver for a device, the computer system comprising:
means for gathering operating system information associated with the operating system and device information associated with the device;
means for generating a device identifier by concatenating the operating system information with the device information;
means for selecting the device driver using the device identifier; and
means for installing the selected device driver.

14. An apparatus as in claim 13 further comprising:
means for determining the identity of the operating system; and
means for generating an operating system identifier based on the identity of the operating system; and
means for generating the device identifier by concatenating the operating system identifier with the device information.

15. A computer readable media comprising:
the computer readable media containing computer executable instructions for execution in a processor for the practice of the method of claim 1.
